(19) United States
(12) Patent Application Publication
(10) Pub. No.: US 2025/0343379 A1
(43) Pub. Date: Nov. 6, 2025

(54) CONNECTOR ASSEMBLY HAVING A SIGNAL CONDITIONING MODULE

(71) Applicant: TE Connectivity Solutions GmbH, Schaffhausen (CH)

(72) Inventors: Linda Ellen Shields, Middletown, PA (US); Michael James Horning, Middletown, PA (US); David Wayne Helster, Middletown, PA (US)

(21) Appl. No.: 18/653,226

(22) Filed: May 2, 2024

(51) Int. Cl. H01R 13/6587; H01R 12/73; H01R 13/02; H01R 13/514; H01R 13/518

(52) U.S. Cl. CPC H01R 13/6587; H01R 12/73; H01R 13/02; H01R 13/514; H01R 13/518

(57) ABSTRACT

An electrical connector assembly includes a connector housing holding wafer assemblies arranged in a wafer stack. Each wafer assembly includes a wafer frame, contacts coupled to the wafer frame, a signal conditioning module coupled to the wafer frame, and a cable assembly terminated to the signal conditioning module. The signal conditioning module includes a circuit board and a repeater device mounted to the circuit board. Mating ends of the contacts are mated to mating contacts of a mating connector assembly and terminating ends of the contacts are electrically connected to the circuit board of the signal conditioning module. The contacts and the cables are electrically connected to the repeater device through the circuit board to form data channels and the repeater device restores signals transmitted along the data channels.

### BACKGROUND OF THE INVENTION

The subject matter herein relates generally to electrical connectors for a communication system.

Some electrical systems utilize electrical connector assemblies to interconnect various electrical components, such as of a motherboard and daughtercard. High speed electrical connector assemblies suffer from problems with cross talk and can exhibit signal degradation, such as along long signal traces on circuit boards. As systems signal speeds increase, the data path generally needs to improve accordingly or the length of the data path needs to decrease. Some communication systems make use of active signal conditioning components in the data path. However, locating the active components along the data channels can be difficult. Additionally, supplying power to the active component can be difficult.

A need remains for cost effective and reliable electrical connectors having improved electrical performance.

### BRIEF DESCRIPTION OF THE INVENTION

In one embodiment, an electrical connector assembly is provided and includes a connector housing having housing walls forming a chamber. The electrical connector assembly includes wafer assemblies arranged in a wafer stack. The wafer assemblies received in the chamber and coupled to the connector housing. Each wafer assembly includes a wafer frame, a contact assembly coupled to the wafer frame, a signal conditioning module coupled to the wafer frame, and a cable assembly terminated to the signal conditioning module. The contact assembly is electrically connected to the cable assembly through the signal conditioning module. The signal conditioning module includes a circuit board and a repeater device mounted to the circuit board. The wafer frame includes contact support platforms extending forward of the circuit board. The contact assembly includes a plurality of contacts. The contacts have mating ends and terminating ends. The mating ends extend along the contact support platforms. The mating ends configured to be mated to mating contacts of a mating connector assembly. The terminating ends are electrically connected to the circuit board of the signal conditioning module. The contacts are electrically connected to the repeater device through the circuit board. The cable assembly includes cables terminated to the circuit board. The cables are electrically connected to the repeater device through the circuit board. The cables and the corresponding signal contacts form data channels. The repeater device is configured to restore signals transmitted along the data channels.

In another embodiment, an electrical connector assembly is provided and includes a connector housing having housing walls forming a chamber. The electrical connector assembly includes a busbar held by the housing in the chamber. The electrical connector assembly includes wafer assemblies arranged in a wafer stack. The wafer assemblies are received in the chamber and coupled to the connector housing. Each wafer assembly includes a wafer frame, a contact assembly coupled to the wafer frame, a signal conditioning module coupled to the wafer frame, and a cable assembly terminated to the signal conditioning module. The contact assembly is electrically connected to the cable assembly through the signal conditioning module. The signal conditioning module includes a circuit board and a repeater device mounted to the circuit board. The contact assembly includes a plurality of signal contacts coupled to the wafer frame. The signal contacts have mating ends and terminating ends. The mating ends configured to be mated to mating contacts of a mating connector assembly. The terminating ends are electrically connected to the circuit board of the signal conditioning module. The signal contacts are electrically connected to the repeater device through the circuit board. The contact assembly includes power contacts coupled to the wafer frame. The power contacts are electrically connected to the busbar. The power contacts supplying power from the busbar to the signal conditioning module. The cable assembly includes cables terminated to the circuit board. The cables are electrically connected to the repeater device through the circuit board. The cables and the corresponding contacts form data channels. The repeater device is configured to restore signals transmitted along the data channels.

In a further embodiment, an electrical connector assembly is provided and includes a connector housing having housing walls forming a chamber. The electrical connector assembly includes wafer assemblies arranged in a wafer stack. The wafer assemblies received in the chamber and coupled to the connector housing. Each wafer assembly includes a wafer frame, a contact assembly coupled to the wafer frame, a signal conditioning module coupled to the wafer frame, and a cable assembly terminated to the signal conditioning module. The contact assembly is electrically connected to the cable assembly through the signal conditioning module. The signal conditioning module includes a circuit board and a repeater device mounted to the circuit board. The contact assembly includes a plurality of contacts. The contacts have mating ends and terminating ends. The mating ends have separable mating interfaces. The terminating ends are electrically connected to the circuit board of the signal conditioning module. The contacts include signal contacts and power contacts. The signal contacts forming data channels electrically connected to the repeater device. The power contacts supplying power to the signal conditioning module. The cable assembly includes cables terminated to the circuit board. The cables are electrically connected to the corresponding signal contacts through the repeater device to form the data channels. The repeater device is configured to restore signals transmitted along the data channels.

### BRIEF DESCRIPTION OF THE DRAWINGS

FIG. 1 illustrates a communication system in accordance with an exemplary embodiment.

FIG. 2 is a front perspective, partially exploded view of the first electrical connector assembly in accordance with an exemplary embodiment showing the mating interface.

FIG. 3 is a perspective view of the wafer assembly in accordance with an exemplary embodiment.

FIG. 4 is a perspective view of a portion of the wafer assembly showing the contacts and the cables coupled to the signal conditioning module in accordance with an exemplary embodiment.

FIG. 5 is an end view of a portion of the wafer assembly showing the contacts and the cables coupled to the signal conditioning module in accordance with an exemplary embodiment.

FIG. 6 is a front perspective view of the first electrical connector assembly in accordance with an exemplary embodiment.

FIG. 7 is an exploded view of the first electrical connector assembly in accordance with the exemplary embodiment shown in FIG. 6.

FIG. 8 is a front perspective view of the first electrical connector assembly in accordance with an exemplary embodiment.

FIG. 9 is a partial sectional view of the first electrical connector assembly in accordance with an exemplary embodiment.

FIG. 10 is a first perspective view of the power wafer assembly in accordance with an exemplary embodiment.

FIG. 11 is a second perspective view of the opposite side of the power wafer assembly in accordance with an exemplary embodiment.

FIG. 12 is a side view of the power wafer assembly in accordance with an exemplary embodiment.

FIG. 13 is a partial sectional view of the first electrical connector assembly in accordance with an exemplary embodiment.

FIG. 14 is a first perspective view of the signal wafer assembly in accordance with an exemplary embodiment.

FIG. 15 is a side view of the signal wafer assembly in accordance with an exemplary embodiment.

### DETAILED DESCRIPTION OF THE INVENTION

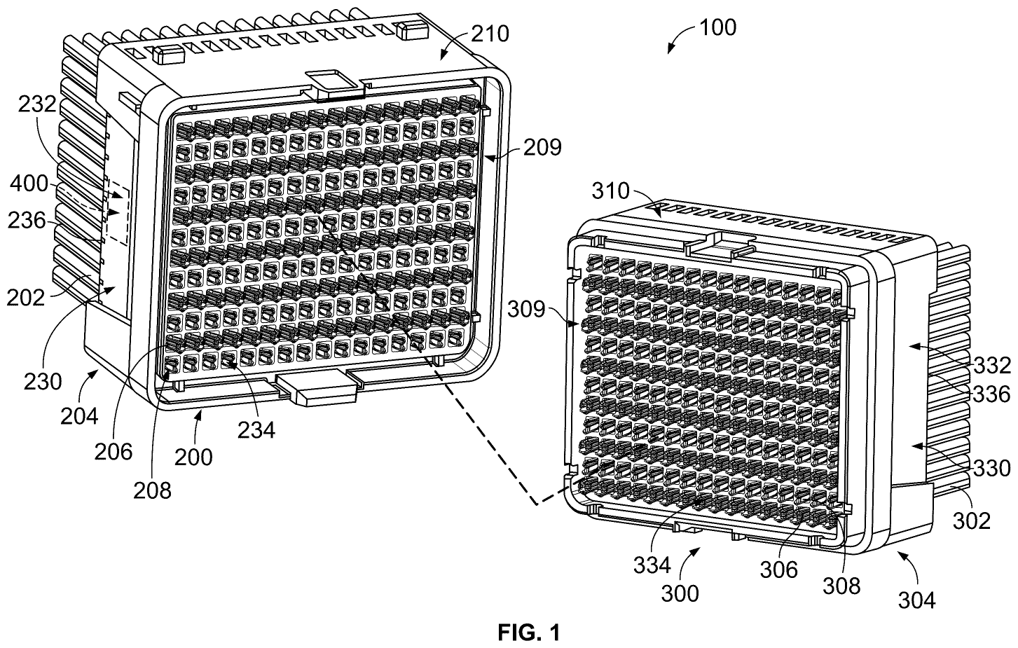

FIG. 1 illustrates a communication system 100 in accordance with an exemplary embodiment. The communication system 100 includes a first electrical connector assembly 200 and a second electrical connector assembly 300 configured to be electrically coupled together. In various embodiments, the communication system 100 may be a server or network switch. In other various embodiments, the communication system 100 may be a backplane system. In various embodiments, the first and second electrical connector assemblies 200, 300 are cable connector assemblies. However, in alternative embodiments, the first electrical connector assembly 200 and/or the second electrical connector assembly 300 may be a circuit board connector mounted to a circuit board.

In an exemplary embodiment, the first and second electrical connector assemblies 200, 300 are directly mated together. For example, the first electrical connector assembly 200 may be plugged into the second electrical connector assembly 300 and/or the second electrical connector assembly 300 may be plugged into the first electrical connector assembly 200. The first and second electrical connector assemblies 200, 300 are mated at a separable mating interface. The first and second electrical connector assemblies 200, 300 are directly mated together without the use of an adapter or additional electrical connector therebetween, such as a midplane connector.

The first electrical connector assembly 200 includes first cables 202 terminated to a first electrical connector 204. The first electrical connector 204 includes an array of first contacts 206 and first shield structures 208 providing electrical shielding for the first contacts 206. The first contacts 206 are arranged in rows and columns. In an exemplary embodiment, the first contacts 206 are arranged in pairs, such as configured to convey differential signals. The pairs may be arranged vertically or horizontally. For example, the pairs may be arranged in rows or in columns. In an exemplary embodiment, the first contacts 206 include power contacts and/or signal contacts.

The second electrical connector assembly 300 includes second cables 302 terminated to a second electrical connector 304. The second electrical connector 304 includes an array of second contacts 306 and second shield structures 308 providing electrical shielding for the second contacts 306. The second contacts 306 are arranged in rows and columns. In an exemplary embodiment, the second contacts 306 are arranged in pairs, such as configured to convey differential signals. In an exemplary embodiment, the second contacts 306 include power contacts and/or signal contacts.

In an exemplary embodiment, the first electrical connector assembly 200 and/or the second electrical connector assembly 300 includes signal conditioning modules 400 for conditioning the signals transmitted along data channels through the connector assemblies 200, 300. The signal conditioning modules 400 may amplify the signals and/or retransmit the signals. For example, the signal conditioning modules 400 may include one or more active components, such as repeater devices, to restore signals transmitted along the data channels. The signal conditioning modules 400 may condition the signals by providing equalization functions, such as to compensate for jitter and in turn transmit a conditioned signal downstream. The signal conditioning modules 400 are strategically placed along the data channels, such as near the mating interface between the connector assemblies 200, 300, to meet budget constraints on the data channels. The signal conditioning modules 400 operate as channel reach extension devices to extend the transmission line length along the data channels. For example, when the channel length of the data channel between the various electrical components of the communication system 100 is longer than an allowable channel length, such as per protocol specifications, the signal conditioning modules 400 restore the signals by passing the data channels through the signal conditioning modules 400. The signal conditioning modules 400 allow reliable, error-free communication for the communication system 100. The signal conditioning modules 400 are configured to restore the signals at some point midway between the end points (for example, the various electrical components in the communication system). The signal conditioning modules 400 are incorporated into the wafer assemblies of the first electrical connector assembly 200 and/or the second electrical connector assembly 300 to avoid the need for mounting additional components onto a circuit board within the communication system, thus shortening the data channels and eliminating costly components and physical space within the system.

In an exemplary embodiment, the first and second electrical connectors 204, 304 have hermaphroditic mating interfaces defined, at least in part, by the contacts 206, 306 and the shield structures 208, 308. For example, the first and second electrical connectors 204, 304 may include both male mating portions and female mating portions that are co-nested during mating to electrically connect the first and second electrical connectors 204, 304. In various embodiments, the first and second electrical connectors 204, 304 may be identical to each other allowing use of the same parts in both the first and second electrical connectors 204, 304. However, in alternative embodiments, the first and second electrical connectors 204, 304 are not identical but rather have complementary mating interfaces. For example, the first electrical connector 204 may be a plug connector and the second electrical connector 304 may be a receptacle connector or header connector. The contacts 206 of the first electrical connector 204 may be pins and the contacts 306 of the second electrical connector 304 may be sockets, or vice versa.

In an exemplary embodiment, the contacts 206, 306 are arranged in rows and columns. The first contacts 206 are arranged for direct mating with the second contacts 306 when the first and second electrical connectors 204, 304 are mated. The shield structures 208, 308 provide electrical shielding around the contacts 206, 306 at the mating interfaces between the contacts 206, 306. In an exemplary embodiment, the first contacts 206 and the first shield structures 208 are pluggable into the second electrical connector 304. The second contacts 306 and the second shield structures 308 are pluggable into the first electrical connector 204. The communication system 100 is a direct plug communication system. The shield structures 208, 308 may provide circumferential shielding around the contacts 206, 306 at the mating interfaces. The shield structures 208, 308 may provide circumferential shielding along the signal paths between the first cables 202 and the second cables 302. Optionally, the shielding may be 360° shielding along the signal paths between the first cables 202 and the second cables 302 for improved signal integrity through the first and second electrical connectors 204, 304.

The contacts 206, 306 and the cables 202, 302 define electrical paths or data channels through the connector assemblies 200, 300 and the communication system 100. The data channels pass through the signal conditioning modules 400 for conditioning the signals transmitted along data channels through the connector assemblies 200, 300. For example, the data channels may pass through active components of the signal conditioning modules 400, such as a repeater devices. The signal conditioning modules 400 may include re-timer devices and/or repeater devices for conditioning the signals.

The contacts 206, 306 mate at a separable mating interface between the first and second electrical connectors 204, 304. For example, the mating interfaces of the contacts 206, 306 are arranged along mating planes (for example, parallel to the columns). In various embodiments, the first contacts 206 are arranged in pairs and the second contacts 306 are arranged in pairs. The shield structures 208, 308 cooperate to provide shielding for the corresponding contacts 206, 306 (for example, pairs of the contacts 206, 306). The shield structures 208, 308 may be electrically connected to shielding structures passing through the electrical connectors 204, 304. The shield structures 208, 308 may provide shielding between the pairs of contacts 206, 306.

The first electrical connector 204 includes a housing 210 having a mating interface configured to be mated with the second electrical connector 304. The mating interface is provided at a front of the housing 210. In an exemplary embodiment, the first electrical connector 204 includes a plurality of wafers assemblies 230 coupled to the housing 210. The wafers assemblies 230 are received in a chamber 209 of the housing 210. Housing walls of the housing 210 surround the chamber 209. The housing 210 may be rectangular.

The wafer assemblies 230 include the contacts 206 and the shield structures 208. The cables 202 are configured to be terminated to corresponding wafer assemblies 230. For example, the wafer assemblies 230 may support the cables 202 and signal conductors of the cables 202. In an exemplary embodiment, each wafer assembly 230 includes the corresponding signal conditioning module 400. The contacts 206 may be terminated to the signal conditioning module 400. The cables 202 may be terminated to the signal conditioning module 400. The signal conditioning module 400 processes the signals along the data paths between the contacts 206 and the cables 202. Power is supplied to the signal conditioning module 400, such as via one or more of the cables 202 or via one or more of the contacts 206. The signal conditioning module 400 may be located, at least partially, in the chamber 209. The cables 202 may extend into the chamber 209. In an exemplary embodiment, the wafer assemblies 230 are oriented vertically. Each wafer assembly 230 includes a corresponding column of the contacts 206 (the columns oriented vertically). The wafer assemblies 230 are stacked in the housing 210 to arrange the contacts 206 in rows. However, other orientations are possible in alternative embodiments, such as with the wafer assemblies 230 oriented horizontally.

In an exemplary embodiment, the wafer assemblies 230 are arranged in a wafer stack 232. For example, the wafer assemblies 230 are parallel to each other in the wafer stack 232. The wafer stack 232 may extend from a rear of the housing 210. Optionally, the wafer assemblies 230 may be individually loaded into the housing 210, such as into the chamber 209 at a rear of the housing 210. Alternatively, the wafer assemblies 230 may be assembled together in the wafer stack 232, and the wafer stack 232 is then loaded into the rear of the housing 210 as a unit.

In an exemplary embodiment, each wafer assembly 230 extends between a mating end 234 and a cable end 236. For example, the mating end 234 may be at the front of the wafer assembly 230 and the cable end 236 may be at the rear of the wafer assembly 230. The cables 202 are terminated to the wafer assembly 230 at the cable end 236. The mating end 234 extends into the housing 210 and is configured to be mated with the second electrical connector 304. In other various embodiments, the wafer assembly 230 may be a right-angle wafer assembly having the mating end 234 at a right angle relative to the cable end 236. The shield structures 208 are provided at the mating end 234 and are configured to be mated with the second electrical connector 304.

The second electrical connector 304 includes a housing 310 having a mating interface configured to be mated with the first electrical connector 204. The mating interface is provided at a front of the housing 310. In an exemplary embodiment, the second electrical connector 304 includes a plurality of wafer assemblies 330 coupled to the housing 310. The wafers assemblies 330 are received in a chamber 309 of the housing 310. The wafer assemblies 330 include the contacts 306 and the shield structures 308. The cables 302 are terminated to the corresponding wafer assemblies 330. Optionally, the wafer assemblies 330 may include corresponding signal conditioning modules (not shown). However, the signal conditioning modules 400 may be unnecessary of the signal conditioning modules 400 are provided in the first electrical connector 204. The cables 302 may extend into the chamber 309. The cables 302 may be terminated to the signal conditioning modules 400. Alternatively, the cables 302 may be terminated directly to the contacts 306. In an exemplary embodiment, the wafer assemblies 330 are oriented vertically. However, other orientations are possible in alternative embodiments. Each wafer assembly 330 includes a corresponding column of the contacts 306. The wafer assemblies 330 are stacked in the housing 310 to arrange the contacts 306 in rows.

In an exemplary embodiment, the wafer assemblies 330 are arranged in a wafer stack 332. For example, the wafer assemblies 330 are parallel to each other in the wafer stack 332. The wafer stack 332 extends from a rear of the housing 310. Optionally, the wafer assemblies 330 may be individually loaded into the housing 310, such as into the chamber 309 at a rear of the housing 310. Alternatively, the wafer assemblies 330 may be assembled together in the wafer stack 332 and the wafer stack 332 is loaded into the rear of the housing 310.

In an exemplary embodiment, each wafer assembly 330 extends between a mating end 334 and a cable end 336. The cables 302 are terminated to the wafer assembly 330 at the cable end 336. The mating end 334 extends into the housing 310 and is configured to be mated with the first electrical connector 204. In various embodiments, the wafer assembly 330 may be a right-angle wafer assembly having the mating end 334 at a right angle relative to the cable end 336. The shield structures 308 are provided at the mating end 334 and are configured to be mated with the first electrical connector 204.

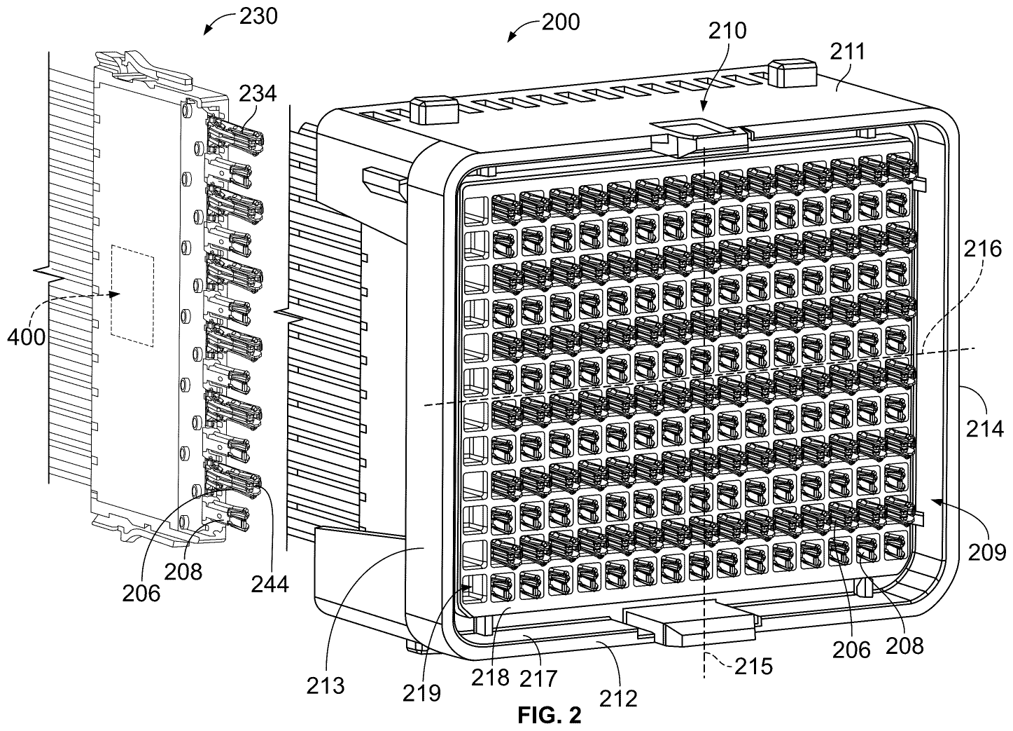

FIG. 2 is a front perspective, partially exploded view of the first electrical connector assembly 200 in accordance with an exemplary embodiment showing the mating interface. The second electrical connector assembly 300 (FIG. 1) may have similar or identical components and like components may be identified with like reference numerals. One of the wafer assemblies 230 is shown poised for loading into the housing 210. The housing 210 holds the contacts 206 and the shield structures 208 for mating with the second electrical connector 304 (shown in FIG. 1). The housing 210 forms part of the mating interface with the second electrical connector 304. The wafer assemblies 230 include the signal conditioning modules 400 for conditioning the signals transmitted along the data channels through the wafer assemblies 230.

The housing 210 has a top 211 and a bottom 212. The housing 210 has a first side 213 and a second side 214 opposite the first side 213. The housing 210 has a primary axis 215 extending from the top 211 to the bottom 212 and a secondary axis 216 extending from the first side 213 to the second side 214. The secondary axis 216 is perpendicular to the primary axis 215. In an exemplary embodiment, the contacts 206 and the shield structures 208 are arranged in columns parallel to the primary axis 215 and rows parallel to the secondary axis 216. The mating ends 234 are arranged along mating planes parallel to the primary axis 215 for interfacing with the second contacts 306 (FIG. 1). The wafer assemblies 230 are received in the housing 210 such that the wafer assemblies 230 are oriented parallel to the primary axis 215. However, the wafer assemblies 230 may be received in the housing 210 such that the wafer assemblies 230 are oriented parallel to the secondary axis 216.

In an exemplary embodiment, the housing 210 is a multi-piece housing including an outer shroud 217 and a commoning member 218. The outer shroud 217 defines the chamber 209. The outer shroud 217 may be manufactured from a different material from the communing member 218. The commoning member 218 is positioned in the outer shroud 217, such as near the front of the housing 210. The outer shroud 217 may include locating features for locating the commoning member 218 relative to the outer shroud 217. In alternative embodiments, the housing 210 may be a single piece housing, such as being a molded part. The housing 210 may be plated plastic to provide shielding.

In an exemplary embodiment, the commoning member 218 faces the second electrical connector 304. The commoning member 218 is electrically conductive and is used to electrically common each of the shield structures 208. The commoning member 218 provides electrical shielding for the contacts 206 at the mating interface. The commoning member 218 may be electrically connected to the shield structures 308 (shown in FIG. 1) of the second electrical connector 304.

In an exemplary embodiment, the communing member 218 includes openings 219 that receive portions of the wafer assemblies 230, such as the mating ends of the contacts 206 and/or the shield structure 208. For example, contact support platforms 244 of the wafer assemblies 230 may pass through the openings 219 to support the mating ends of the contacts 206 and the shield structures 208. The contact support platforms 244 may pass through the openings 219 and extend forward of the front of the commoning member 218, such as for interfacing with the second electrical connector 304. For example, the contact support platforms 244 are configured to be received in corresponding openings in a commoning member of the second electrical connector 304. The wafer assemblies 230 are coupled to the housing 210 rearward of the communing member 218. The contacts 206 are electrically isolated from each other and from the shield structures 208 by the dielectric material of the contact support platforms 244.

The commoning member 218 is manufactured from a conductive material. For example, the commoning member 218 may be a metal block having the openings 219 formed therethrough. In alternative embodiments, the commoning member 218 may be manufactured from a conductive plastic. In other various embodiments, the commoning member 218 may be a plated plastic structure having plating at the front and/or through the openings 219 and/or at the rear. The shield structures 208 are configured to be electrically connected to the commoning member 218. For example, the shield structures 208 may engage the commoning member 218 within the openings 219. In an exemplary embodiment, the openings 219 are rectangular. In the illustrated embodiment, the openings 219 are square shaped. However, the openings 219 may have other shapes.

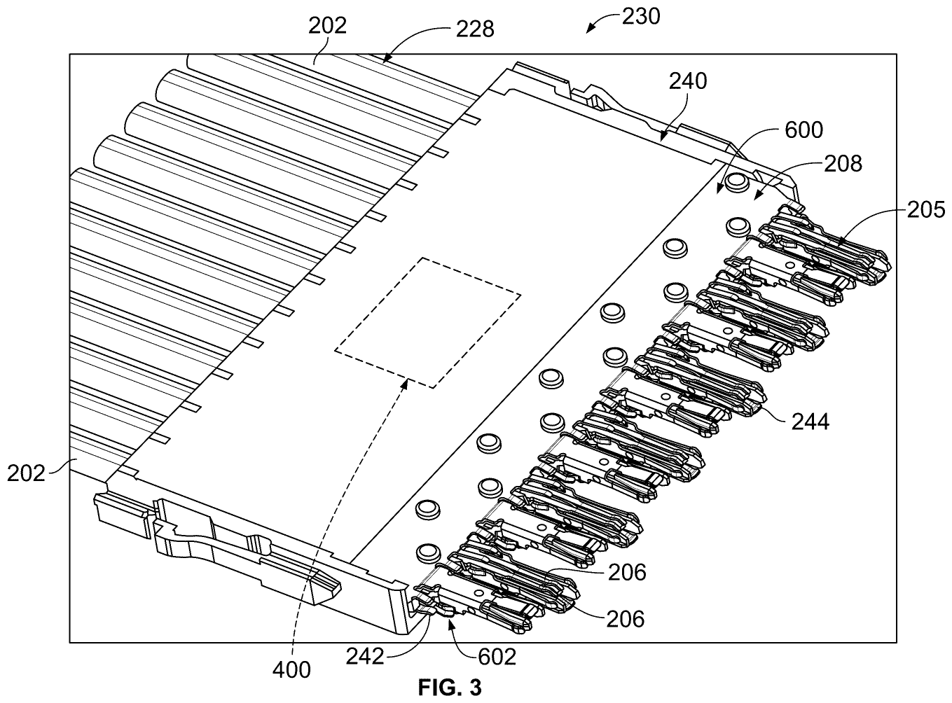

FIG. 3 is a perspective view of the wafer assembly 230 in accordance with an exemplary embodiment. The wafer assembly 230 includes a wafer frame 240, the signal conditioning module 400 coupled to the wafer frame 240, a contact assembly 205 held by the wafer frame 240 and coupled to the signal conditioning module 400, and a cable assembly 228 terminated to the signal conditioning module 400. The contact assembly 205 is electrically connected to the cable assembly 228 through the signal conditioning module 400. The signal conditioning modules 400 conditions the signals transmitted along the data channels through the wafer assemblies 230. The signal conditioning module 400 may amplify the signals and/or retransmit the signals. For example, the signal conditioning module 400 may include one or more active components, such as repeater devices, to restore signals transmitted along the data channels.

The wafer frame 240 is a dielectric structure. For example, the wafer frame 240 may be manufactured from a plastic material. The dielectric structure forms a wafer body 246 of the wafer frame 240. In an exemplary embodiment, the wafer body 246 is a molded part. In various embodiments, the wafer body 246 may be an overmold body overmolded over various components of the wafer assembly 230, such as the contacts 206 and/or the signal conditioning module 400 and/or the cables 202.

The cable assembly 228 includes a plurality of the cables 202. The ends of the cables 202 are terminated to the signal conditioning module 400. For example, the conductors of the cables 202 may be soldered to the signal conditioning module 400. The cables 202 may be shielded. The termination of the cables 202 to the signal conditioning module 400 may be shielded. Optionally, the wafer body 246 may surround the ends of the cables 202 at the cable termination, such as to provide strain relief. The wafer body 246 may at least partially surround the signal conditioning module 400. In various embodiments, the signal conditioning module 400 may be embedded in the wafer body 246. For example, the signal conditioning module 400 may completely enclose the signal conditioning module 400. The wafer body 246 may be a multi-piece body, such as including a main body holding the signal conditioning module 400, a front portion holding the contacts 206, and a rear portion holding the cables 202. The portions may be connected or may be discontinuous.

The wafer assembly 230 includes the contacts 206 and the shield structures 208. In an exemplary embodiment, the wafer assembly 230 includes one or more leadframe(s) forming the contacts 206. The leadframe(s) may be stamped and formed to form the contacts 206. The leadframe(s) may be coupled to the wafer frame 240. For example, the contacts 206 may be loaded into openings or channels in the wafer frame 240. In other various embodiments, the leadframe(s) may be overmolded by a dielectric overmold body forming the wafer frame 240. The wafer frame 240 holds the contacts 206 relative to each other and relative to the signal conditioning module 400. In an exemplary embodiment, the wafer frame 240 includes the contact support platforms 244 that support the contacts 206. Optionally, the contacts 206 may be arranged in pairs, with each pair extending along the corresponding contact support platform 244. Optionally, the contact support platforms 244 may be offset, such as staggered along the first side and the second side of the wafer assembly 230. The contacts 206 may be arranged on different sides of the contact support platforms 244, such as being staggered along right sides and left sides of the contact support platforms 244.

In an exemplary embodiment, the wafer assembly 230 includes a first ground frame 600 coupled to a first side of the wafer frame 240 and a second ground frame 602 coupled to a second side of the wafer frame 240. However, the wafer assembly 230 may be provided with a single ground frame (for example, the first ground frame 600 or the second ground frame 602) in alternative embodiments. The first and second ground frames 600, 602 form portions of the shield structures 208. The first and second ground frames 600, 602 provide electrical shielding for the contacts 206.

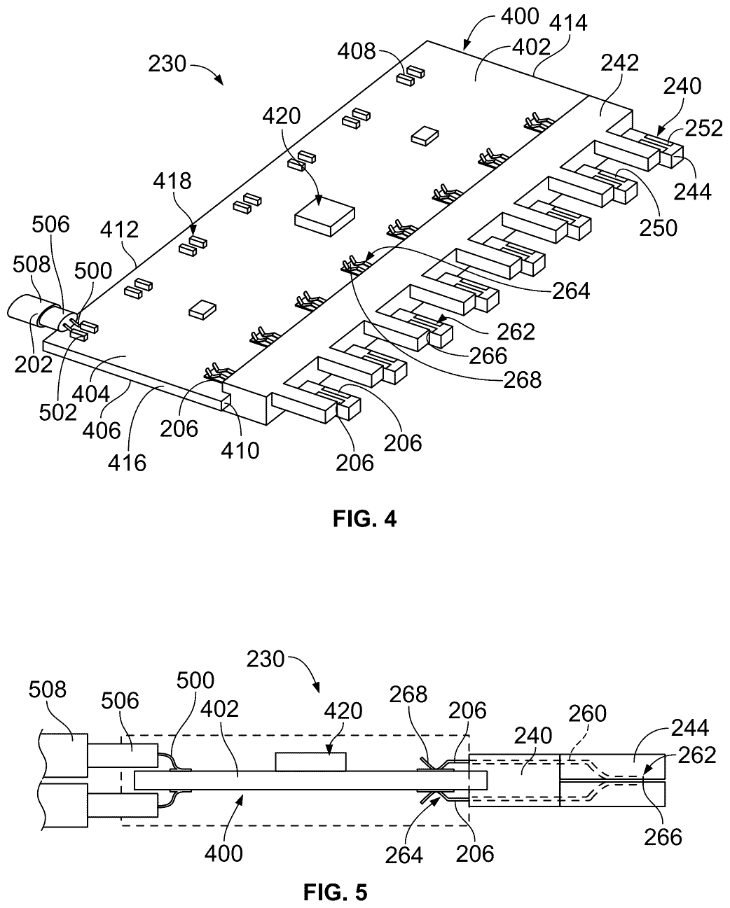

FIG. 4 is a perspective view of a portion of the wafer assembly 230 showing the contacts 206 and the cables 202 coupled to the signal conditioning module 400 in accordance with an exemplary embodiment. FIG. 5 is an end view of a portion of the wafer assembly 230 showing the contacts 206 and the cables 202 coupled to the signal conditioning module 400 in accordance with an exemplary embodiment. A front portion 242 of the wafer frame 240 is shown supporting the contacts 206. The front portion 242 includes the contact support platforms 244. The signal conditioning module 400 may be coupled to the front portion 242. For example, the front portion 242 of the wafer frame 240 may extend forward of the signal conditioning module 400.

The signal conditioning module 400 includes a circuit board 402 and one or more active components, such as repeater devices 420, for providing signal conditioning for the data channels of the wafer assembly 230. The circuit board 402 includes a first side 404 and a second side 406. The circuit board 402 may include the repeater device(s) 420 on the first side 404 and/or the second side 406. The circuit board 402 may include other electrical components 408 mounted to the first side 404 and/or the second side 406, such as capacitors, transistors, resistors, memory components, microcontrollers, EEPROM devices, and the like.

The circuit board 402 extends between a front 410 and a rear 412. The circuit board 402 includes a first edge 414, such as a top edge, and a second edge 416, such as a bottom edge. The circuit board 402 includes circuits 418, such as traces, pads, vias, or other types of circuits routed on one or more layers of the circuit board 402. The repeater devices 420 and the electrical components 408 are electrically connected to the corresponding circuit 418. The signal contacts 206 are configured to be electrically connected to the circuit board 402 at the corresponding circuits 418, such as at the front 410. For example, ends of the contacts 206 may include solder tabs configured to be soldered to pads or other types of circuits 418 of the circuit board 402. The cables 202 are configured to be electrically connected to the circuit board 402 at the corresponding circuits 418, such as at the rear 412. For example, the conductors of the cables 202 may be soldered to pads or other types of circuits 418 of the circuit board 402. In an exemplary embodiment, the signal contacts 206 and/or the cables 202 may be terminated to both sides 404, 406 of the circuit board 402.

In an exemplary embodiment, each cable 202 includes at least one conductor configured to be electrically connected to the circuit board 402. In an exemplary embodiment, the cables 202 are twin-axial cables each having a pair of conductors configured to be electrically connected to the circuit board 402. The cables 202 may be shielded cables, such as including a cable shield extending the length of the cable 202 and circumferentially surrounding the conductor(s). Other types of cables may be used in alternative embodiments, such as coaxial cables, flat flexible cables, and the like.

The cables 202 are configured to be electrically connected to the corresponding signal contacts 206, such as through the circuit board 402 and the repeater device(s) 420. The cables 202 and the signal contacts 206 form data channels through the circuit board 402 and the repeater devices 420. The repeater devices 420 may be integrated circuits. The repeater device 420 conditions the signals transmitted along the data channels. The repeater device 420 may restore signals transmitted along the data channels. For example, the repeater device 420 may amplify the signals and/or retransmit the signals. The repeater device 420 may condition the signals by providing equalization functions, such as to compensate for jitter and in turn transmit a conditioned signal downstream. The repeater device 420 is placed along the data channels within the wafer assembly 230 to allow signal conditioning in-line along the data channels, such as midway between the various electrical components of the communication system. As such, the signal conditioning module 400 operates as a channel reach extension device to extend the transmission line length along the data channels. The repeater device 420 provides reliable, error-free communication for the communication system.

The repeater device(s) 420 are mounted to the circuit board 402, such as to the first side 404 and/or the second side 406. The repeater device 420 may be a re-timer device in various embodiments. In various embodiments, the re-timer device may be an x-16 re-timer device having sixteen channels. The re-timer device is configured to retransmit a fresh copy of the original signal. The re-timer device may be a mixed signal analog/digital device that is protocol-aware and has the ability to fully recover the data, extract the embedded clock and retransmit a fresh copy of the data using a clean clock. The re-timer device may include a continuous time linear equalizer (CTLE) and a wideband gain stage. The re-timer device may include a clock and data recovery (CDR) circuit, a decision feedback equalizer (DFE) and a transmit (Tx) finite impulse response (FIR) driver. The re-timer device may include a finite state machines (FSMs) and/or a microcontroller to manage the automatic adaptation of the CTLE, wideband gain, DFE and FIR driver, and implement a link training and status state machine (LTSSM). The re-timer device may actively participate in the protocol. The re-timer device may fully recover the data stream and retransmit the data signal on a clean clock to enable extension of the channel to twice the original specification. The DFE of the re-timer device compensates for reflections in the channel response caused by impedance discontinuities in board vias, connectors and package socket-board interfaces along the data transmission line. The re-timer device may examine the received signal and adjust the CTLE and DFE to minimize the bit error rate (BER). The transmitter of the re-timer device may adjust de-emphasis and pre-shoot equalization to minimize BER according to equalization protocol. The re-timer device may have tools for assessing the electrical performance (internal eye monitors, pattern generators, pattern checkers) and protocol performance (link state history monitors, timeout adjustments). The re-timer device may compensate and reset any lane-to-lane skew, effectively doubling the specification budget.

The repeater device 420 may be a re-driver device in various embodiments. The re-driver device is configured to amplify the signal that is transmitted downstream of the re-driver device. The re-driver device may be an analog reach extension device designed to boost the high-frequency portions of the signal, such as to counteract frequency-dependent attenuation along the data channel. The re-driver device may include a continuous time linear equalizer (CTLE), a wideband gain stage and a linear driver. The re-driver device may include receive (RX) side equalizer (EQ) to compensate for frequency-dependent attenuation due to PCB traces or cable conductors along the transmission line. The CTLE may function to open the closed eye of the distorted waveform. The transmit (TX) side of the re-driver device may include a pre-emphasis function (transmit equalizer) to pre-shape the transmit waveform.

In an exemplary embodiment, the cables 202 are shielded cables. In an exemplary embodiment, each cable 202 is a twin-axial cable having a pair of signal conductors, namely a first signal conductor 500 and a second signal conductor 502. The signal conductors 500, 502 are arranged as a signal pair. The signal conductors 500, 502 are held by an insulator(s). A cable shield 506 surrounds the insulator. The cable shield 506 provides shielding for the signal pair of signal conductors 500, 502 along the length of the cable 202. A cable jacket 508 surrounds the cable shield 506.

In an exemplary embodiment, the leadframe is a stamped and formed leadframe that forms the contacts 206 from a metal sheet. In an exemplary embodiment, the leadframe includes signal contacts 250. The signal contacts 250 are configured to carry data signals, such as between the second electrical connector 304 and the signal conditioning module 400. In an exemplary embodiment, the signal contacts 250 are arranged in pairs configured to carry differential signals. However, the contacts 206 may be single ended signal contacts in alternative embodiments. In an exemplary embodiment, the leadframe includes power contacts 252. The power contacts 252 are configured to supply power to the signal conditioning module 400. The power contacts 252 may be electrically connected to the second electrical connector 304 to receive the power from the second electrical connector 304. The power contacts 252 may be electrically connected to another component to receive the power supply, such as a busbar. In the illustrated embodiment, the outermost contacts 206 (for example, one or more pairs at the ends), such as at the top and/or the bottom of the wafer assembly 230 are the power contacts 252 and the inner contacts are the signal contacts 250. Other arrangements are possible in alternative embodiments. The number of power contacts 252 may be selected to achieve a desired current or voltage supply to the signal conditioning module 400. In the illustrated embodiment, the wafer assembly 230 includes four power contacts 252 at the top and four power contacts 252 at the bottom and twenty-four signal contacts 250 between the power contacts 252. Greater or fewer power contacts 252 and/or signal contacts 250 may be provided in alternative embodiments.

Each signal contact 250 includes a contact body 260 extending between a mating end 262 and a terminating end 264. In an exemplary embodiment, the contact body 260 is stamped and formed as part of the leadframe. The signal contact 250 includes a spring beam 266 at the mating end 262. The spring beam 266 is deflectable and configured to be mated with a corresponding spring beam of the second signal contact 306 (shown in FIG. 1). The mating end may include other types of contacts, such as pins, sockets, tuning fork contacts, and the like. In an exemplary embodiment, the signal contact 250 includes a solder pad 268 at the terminating end 264 for soldering or welding to the signal conditioning module 400. The signal contact 250 may include a spring beam or other type of termination at the terminating end 264 in other embodiments.

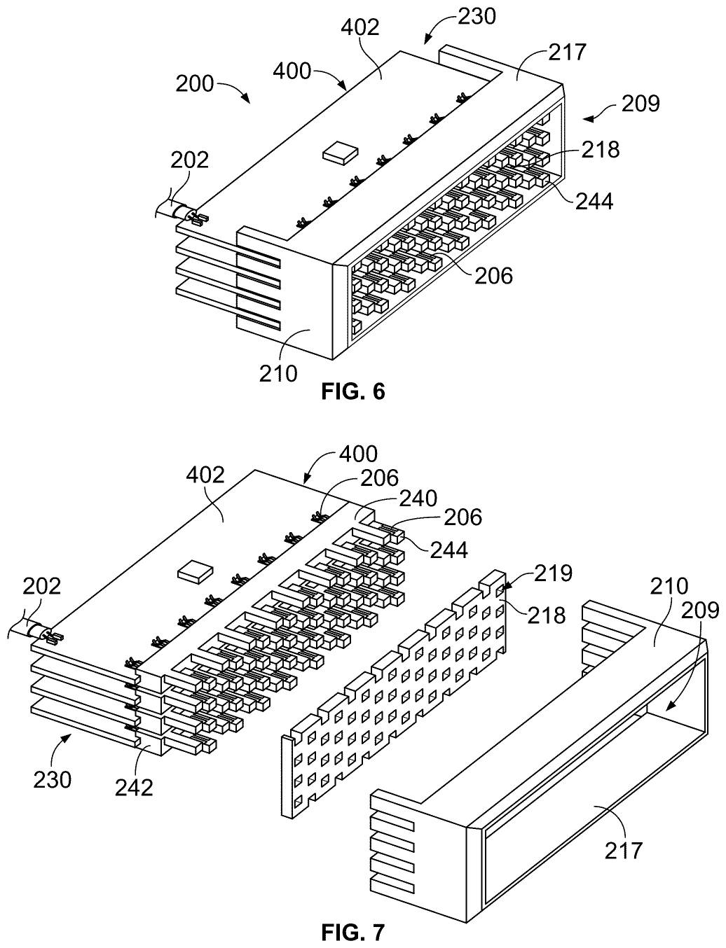

FIG. 6 is a front perspective view of the first electrical connector assembly 200 in accordance with an exemplary embodiment. FIG. 7 is an exploded view of the first electrical connector assembly 200 in accordance with the exemplary embodiment shown in FIG. 6. The first electrical connector assembly 200 may be similar to the embodiment of the first electrical connector assembly 200 shown in FIGS. 1-5 and like components are identified with like reference numerals. In the illustrated embodiment, the wafer assemblies 230 are oriented horizontally rather than vertically. As such, the signal conditioning modules 400 are arranged in the wafer stack horizontally. The contacts 206 are arranged in rows and columns. For example, the pairs of the contacts 206 are in-row, extending along the wafer assemblies 230.

The first electrical connector assembly 200 includes the housing 210 including the communing member 218 arranged in the chamber 209 of the outer shroud 217 of the housing 210. The contacts 206 and the contact support platforms 244 are configured to be received in the openings 219 in the commoning member 218. The front portion 242 of the wafer frame 240 holds the contacts 206 relative to each other and relative to the circuit board 402 of the signal conditioning modules 400 for termination to the circuit board 402 and for loading through the openings 219.

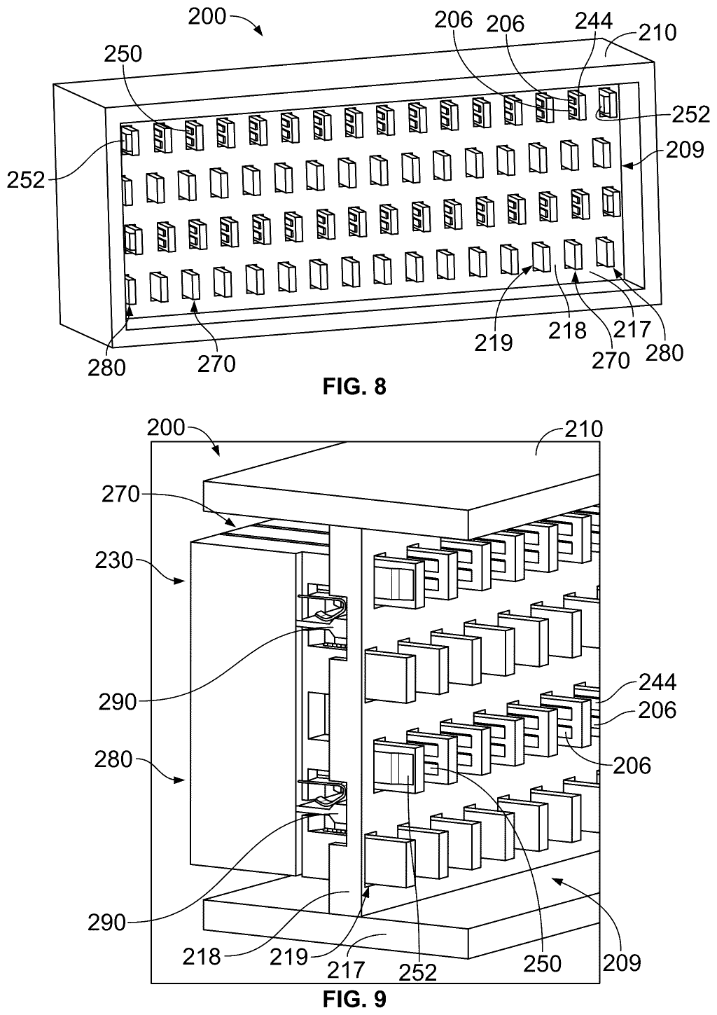

FIG. 8 is a front perspective view of the first electrical connector assembly 200 in accordance with an exemplary embodiment. The first electrical connector assembly 200 may be similar to the embodiment of the first electrical connector assembly 200 shown in FIGS. 1-5 and like components are identified with like reference numerals. In the illustrated embodiment, the wafer assemblies 230 are oriented vertically. The contacts 206 are arranged in rows and columns. For example, the pairs of the contacts 206 are in-row, extending along the wafer assemblies 230.

The first electrical connector assembly 200 includes the housing 210 including the communing member 218 arranged in the chamber 209 of the outer shroud 217 of the housing 210. The contacts 206 and the contact support platforms 244 are configured to be received in the openings 219 in the commoning member 218.

In an exemplary embodiment, the wafer assemblies 230 include signal wafer assemblies 270 and power wafer assemblies 280. The signal wafer assemblies 270 includes a plurality of the signal contacts 250 for transferring data signals through the first electrical connector assembly 200. In an exemplary embodiment, each of the signal wafer assemblies 270 includes the corresponding signal conditioning module 400. The power wafer assemblies 280 include a plurality of the power contacts 252 for transferring power through the first electrical connector assembly 200, such as for powering the signal conditioning modules 400 of the signal wafer assemblies 270. In an exemplary embodiment, the first electrical connector assembly 200 includes one or more busbars 290 (shown in phantom) configured to supply power through the first electrical connector assembly 200. The power wafer assemblies 280 are electrically connected to the busbars 290 to supply power to the busbars 290. The signal wafer assemblies 270 are electrically connected to the busbars 290 to supply power to the signal conditioning modules 400.

FIG. 9 is a partial sectional view of the first electrical connector assembly 200 in accordance with an exemplary embodiment. FIG. 9 shows the power wafer assembly 280 in the chamber 209 of the housing 210. The power wafer assembly 280 is electrically connected to the busbar 290. The power wafer assembly 280 is configured to supply power to the busbar 290. Ground frames or other shielding is not shown in FIG. 9 to provide shielding for the power wafer assembly 280.

The busbar 290 is held by the housing 210. In an exemplary embodiment, the busbar 290 is coupled to the commoning member 218. The busbar 290 extends rearward of the commoning member 218. In the illustrated embodiment, the busbar 290 extends horizontally, such as along the entire width of the first electrical connector assembly 200 to interface with each of the wafer assemblies 230, such as each of the power wafer assemblies 280 and each of the signal wafer assemblies 270. The busbar 290 includes an upper surface 292 and a lower surface 294. The busbar 290 may include one or more metal plates. Optionally, the busbar 290 may be a laminated structure having an upper plate and a lower plate, which may be positive and negative plates such as a cathode and an anode. Alternatively, the upper busbar 290 may be a positive plate (cathode) and the lower busbar 290 may be a negative plate (anode).

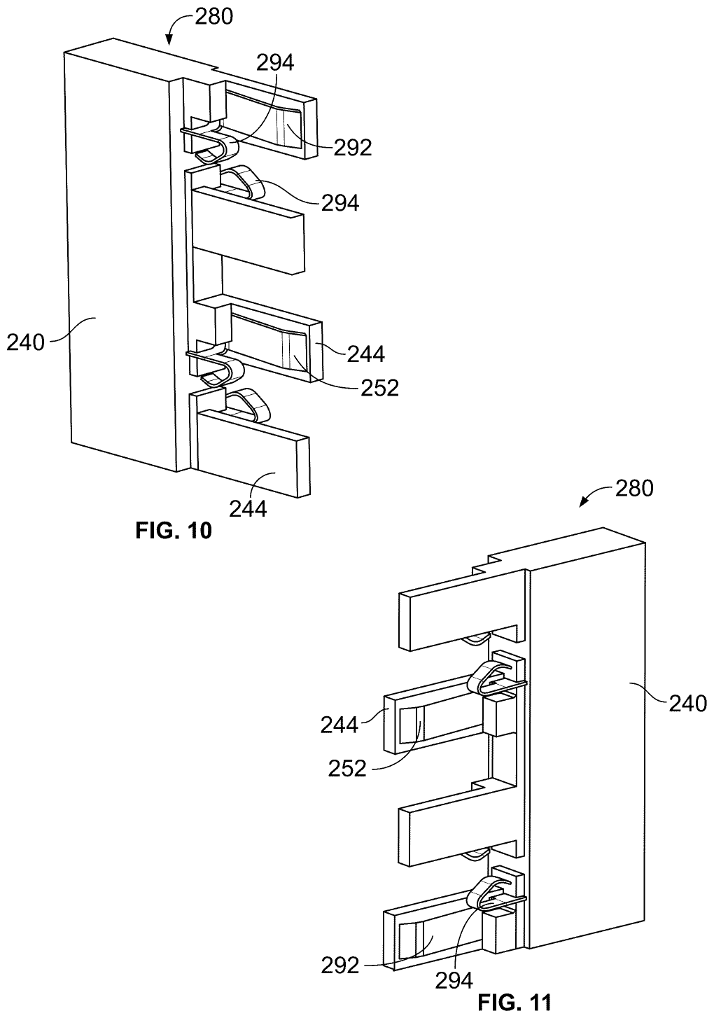

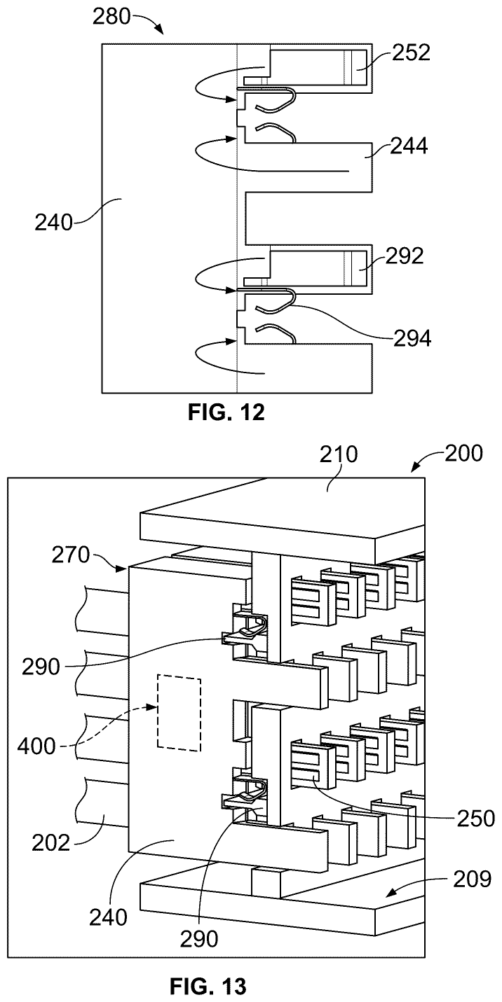

FIG. 10 is a first perspective view of the power wafer assembly 280 in accordance with an exemplary embodiment. FIG. 11 is a second perspective view of the opposite side of the power wafer assembly 280 in accordance with an exemplary embodiment. FIG. 12 is a side view of the power wafer assembly 280 in accordance with an exemplary embodiment. The power wafer assembly 280 includes the wafer body 246 with the contact support platforms 244 at the front of the wafer body 246. The power contacts 252 extend along the contact support platforms 244.

The power contacts 252 include mating portions 292 configured to be mated with the corresponding mating portion of the power contact of the second electrical connector 304. In various embodiments, the mating portions 292 includes spring beams having separable mating interfaces. Other types of mating portions may be provided in alternative embodiments. In the illustrated embodiment, each contact support platform 244 supports a single power contact 252 having a single mating portion 292. In alternative embodiments, each contact support platform 244 may support multiple power contacts 252.

The power contacts 252 include terminating portions 294 configured to be electrically connected to the busbar 290 (shown in FIG. 9). In various embodiments, the terminating portions 292 include deflectable spring beams having separable mating interfaces configured to be spring biased against the busbar 290. The terminating portions 292 are configured to interface with the busbar 290 at a location generally between the contact support platforms 244. For example, the busbar 290 may extend in the space between the contact support platforms 244. The terminating portions 294 are integral with the mating portions 292. For example, the power contacts 252 may be stamped and formed contacts. The terminating portions 294 may be bent perpendicular to the mating portions 292 to interface with the busbars 290. For example, the mating portions 292 may be oriented generally vertically and the terminating portions 292 may be oriented generally horizontally. The power contacts 252 transmit the power from the mating portions 292 to the terminating portions 294 to supply power from the second electrical connector 304 to the busbars 290. The power contacts 252 may have other shapes in alternative embodiments.

FIG. 13 is a partial sectional view of the first electrical connector assembly 200 in accordance with an exemplary embodiment. FIG. 13 shows the signal wafer assembly 270 in the chamber 209 of the housing 210. The signal wafer assembly 270 includes the wafer body 246 holding the signal contacts 250 and the signal conditioning module 400. The cables 202 extend from the rear of the signal wafer assembly 270. The signal wafer assembly 270 is electrically connected to the busbar 290, such as to receive power from the busbar 290. The signal wafer assembly 270 is configured to supply power to the signal conditioning module 400. Ground frames or other shielding is not shown in FIG. 13 to provide shielding for the signal wafer assembly 270.

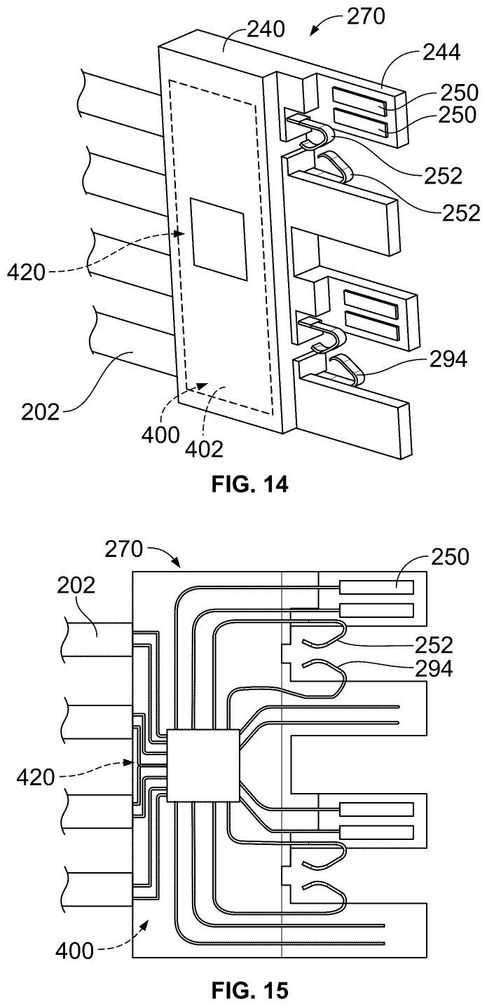

With additional reference to FIGS. 14 and 15, FIG. 14 is a first perspective view of the signal wafer assembly 270 in accordance with an exemplary embodiment and FIG. 15 is a side view of the signal wafer assembly 270 in accordance with an exemplary embodiment. The signal wafer assembly 270 includes the wafer body 246 with the contact support platforms 244 at the front of the wafer body 246. The signal contacts 250 extend along the contact support platforms 244. The signal contacts 250 are electrically connected to the signal conditioning module 400 to form data channels through the signal wafer assembly 270 to the cables 202. The wafer body 246 supports the signal conditioning module 400. The wafer body 246 may enclose or encapsulate at least a portion of the signal conditioning module 400. For example, the wafer body 246 may be molded around the signal conditioning module 400. The repeater device(s) 420 may be embedded in the wafer body 246. The circuit board 402 of the signal conditioning module 400 may be embedded in the wafer body 246. The cables 202 may extend into the wafer body 246. The signal contacts 250 and the cables 202 are electrically connected to the repeater device(s) 420 through corresponding traces of the circuit board 402.

In an exemplary embodiment, the signal wafer assemblies 270 include corresponding power contacts 252 configured to be electrically connected to the busbar 290. The power contacts 252 extend forward of the wafer body 246. The power contacts 252 include the terminating portions 294 configured to be electrically connected to the busbar 290 (FIG. 13). In various embodiments, the terminating portions 292 include deflectable spring beams having separable mating interfaces configured to be spring biased against the busbar 290. The terminating portions 292 are configured to interface with the busbar 290 at a location generally between the contact support platforms 244. For example, the busbar 290 may extend in the space between the contact support platforms 244. The power contacts 252 are configured to be electrically connected to the circuit board 402 of the signal conditioning module 400. For example, ends of the power contacts 252 may be soldered to circuits or pads on the circuit board 402 to supply power to the signal conditioning module 400. The power is supplied to the repeater device(s) 420.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector assembly comprising:
a connector housing having housing walls forming a chamber; and
wafer assemblies arranged in a wafer stack, the wafer assemblies received in the chamber and coupled to the connector housing, each wafer assembly including a wafer frame, a contact assembly coupled to the wafer frame, a signal conditioning module coupled to the wafer frame, and a cable assembly terminated to the signal conditioning module, wherein the contact assembly is electrically connected to the cable assembly through the signal conditioning module;
the signal conditioning module including a circuit board and a repeater device mounted to the circuit board;
the wafer frame including contact support platforms extending forward of the circuit board;
the contact assembly including a plurality of contacts, the contacts having mating ends and terminating ends, the mating ends extending along the contact support platforms, the mating ends configured to be mated to mating contacts of a mating connector assembly, the terminating ends being electrically connected to the circuit board of the signal conditioning module, the contacts being electrically connected to the repeater device through the circuit board;
the cable assembly including cables terminated to the circuit board, the cables being electrically connected to the repeater device through the circuit board;
wherein the cables and the corresponding signal contacts form data channels, the repeater device is configured to restore signals transmitted along the data channels.

2. The electrical connector assembly of claim 1, wherein the contacts include signal contacts and power contacts, the signal contacts forming the data channels, the power contacts supplying power to the signal conditioning module.

3. The electrical connector assembly of claim 2, wherein the power contacts extend along the corresponding contact support platforms to interface with the mating power contacts of the mating connector assembly.

4. The electrical connector assembly of claim 2, wherein the power contacts are coupled to a busbar configured to supply power to the signal conditioning module.

5. The electrical connector assembly of claim 1, further comprising a busbar coupled to the connector housing and arranged in the chamber, the busbar supplying power to the signal conditioning module.

6. The electrical connector assembly of claim 5, wherein the wafer assemblies include at least one power wafer assembly electrically connected to the busbar to supply power to the busbar.

7. The electrical connector assembly of claim 1, wherein the repeater device is a re-timer device.

8. The electrical connector assembly of claim 1, wherein the wafer frame includes a wafer body surrounding portions of the contacts.

9. The electrical connector assembly of claim 8, wherein the wafer body surround at least a portion of the circuit board.

10. The electrical connector assembly of claim 8, wherein the wafer body surrounds ends of the cables.

11. The electrical connector assembly of claim 8, wherein the wafer body is overmolded over the portions of the contacts.

12. The electrical connector assembly of claim 1, wherein the circuit boards of the signal conditioning modules of the wafer assemblies are arranged parallel to each other in the wafer stack.

13. The electrical connector assembly of claim 1, wherein the signal contacts are arranged in pairs, the signal contacts of each pair received on the same contact support platform.

14. The electrical connector assembly of claim 1, wherein the wafer assembly includes shield elements extending along the mating ends of the contacts providing electrical shielding for the contacts.

15. An electrical connector assembly comprising:
a connector housing having housing walls forming a chamber;
a busbar held by the housing in the chamber; and
wafer assemblies arranged in a wafer stack, the wafer assemblies received in the chamber and coupled to the connector housing, each wafer assembly including a wafer frame, a contact assembly coupled to the wafer frame, a signal conditioning module coupled to the wafer frame, and a cable assembly terminated to the signal conditioning module, wherein the contact assembly is electrically connected to the cable assembly through the signal conditioning module;
the signal conditioning module including a circuit board and a repeater device mounted to the circuit board;
the contact assembly including a plurality of signal contacts coupled to the wafer frame, the signal contacts having mating ends and terminating ends, the mating ends configured to be mated to mating contacts of a mating connector assembly, the terminating ends being electrically connected to the circuit board of the signal conditioning module, the signal contacts being electrically connected to the repeater device through the circuit board;
the contact assembly including power contacts coupled to the wafer frame, the power contacts being electrically connected to the busbar, the power contacts supplying power from the busbar to the signal conditioning module;
the cable assembly including cables terminated to the circuit board, the cables being electrically connected to the repeater device through the circuit board;
wherein the cables and the corresponding contacts form data channels, the repeater device is configured to restore signals transmitted along the data channels.

16. The electrical connector assembly of claim 15, wherein the wafer assemblies include at least one signal wafer assembly and at least one power wafer assembly, the at least one signal wafer assembly configured to transferring signals between the mating connector assembly and the signal conditioning module, the at least one power wafer assembly configured to transfer power between the mating connector assembly and the busbar.

17. The electrical connector assembly of claim 15, wherein the wafer frame includes contact support platforms extending forward of the circuit board, the mating ends of the signal contacts extending along the contact support platforms, mating ends of the power contacts being coupled to the busbar.

18. An electrical connector assembly comprising:
a connector housing having housing walls forming a chamber; and
wafer assemblies arranged in a wafer stack, the wafer assemblies received in the chamber and coupled to the connector housing, each wafer assembly including a wafer frame, a contact assembly coupled to the wafer frame, a signal conditioning module coupled to the wafer frame, and a cable assembly terminated to the signal conditioning module, wherein the contact assembly is electrically connected to the cable assembly through the signal conditioning module;
the signal conditioning module including a circuit board and a repeater device mounted to the circuit board;
the contact assembly including a plurality of contacts, the contacts having mating ends and terminating ends, the mating ends having separable mating interfaces, the terminating ends being electrically connected to the circuit board of the signal conditioning module, the contacts including signal contacts and power contacts, the signal contacts forming data channels electrically connected to the repeater device, the power contacts supplying power to the signal conditioning module;
the cable assembly including cables terminated to the circuit board, the cables being electrically connected to the corresponding signal contacts through the repeater device to form the data channels, wherein the repeater device is configured to restore signals transmitted along the data channels.

19. The electrical connector assembly of claim 18, wherein the wafer frame includes contact support platforms extending forward of the circuit board, the mating ends of the signal contacts extending along the contact support platforms, the mating ends of the power contacts extending along the contact support platforms.

20. The electrical connector assembly of claim 18, wherein the mating ends are configured to be mated to mating contacts of a mating connector assembly, the signal contacts configured to transferring signals between the mating connector assembly and the signal conditioning module, the power contacts configured to transfer power between the mating connector assembly and the signal conditioning module.
